(19) United States
(12) Patent Application Publication
(10) Pub. No.: US 2026/0124813 A1
(43) Pub. Date: May 7, 2026

(54) METHODS AND TOOLING FOR GAP RESIN INFUSION OF COMPOSITES

(71) Applicant: The Boeing Company, Arlington, VA (US)

(72) Inventors: Faith O'Brien, Long Beach, CA (US); David Sorensen Witt, Lakewood, CA (US); Stephen L. Belcher, Doncaster (GB); Daniel Hung Han Chen, Irvine, CA (US); Dat Van Huynh, Anaheim, CA (US); Andres Hernandez, Whittier, CA (US)

(21) Appl. No.: 19/244,760

(22) Filed: Jun. 20, 2025

Related U.S. Application Data
(60) Provisional application No. 63/717,666, filed on Nov. 7, 2024.

(51) Int. Cl. B29C 70/46; B29C 70/68; B29C 70/84

(52) U.S. Cl. CPC B29C 70/461; B29C 70/682; B29C 70/84

(57) ABSTRACT

Resin infusion tooling systems and methods of resin infusion are presented. A resin infusion tooling system comprises a heating tool bed comprising a plurality of cavities formed between a plurality of bed segments movable relative to each other, and a plurality of seals configured to seal the plurality of bed segments together for resin infusion of a plurality of dry stringer preforms in the plurality of cavities. The plurality of cavities is expandable by movement of the plurality of bed segments relative to each other.

### CROSS-REFERENCE TO RELATED APPLICATION

This application claims the benefit of U.S. Provisional Patent Application Ser. No. 63/717,666, filed Nov. 7, 2024, and entitled “Methods and Tooling for Gap Resin Infusion of Composites,” which is incorporated herein by reference in its entirety.

### BACKGROUND INFORMATION

### 1. Field

The present disclosure relates generally to composite manufacturing and more specifically to methods and tooling for gap resin infusion of composites.

### 2. Background

To manufacture reinforced composite panels, composite stringers are joined to composite panels. Composite stringers and panels can be presented as prepreg composite materials or dry fiber preforms. The composite stringers are longitudinal components with a cross-section having a C-shape, T-shape, I-shape, or other desirable cross-sectional shape. The thickness of the composite material is substantially less than the length of the composite stringer. The thin composite material in contrast to the length of the composite stringer increases the difficulty of lifting, positioning, and placing the composite stringer into processing tools.

Therefore, it would be desirable to have a method and apparatus that takes into account at least some of the issues discussed above, as well as other possible issues. For example, it would be desirable to provide a method and apparatus for processing composite stringers.

### SUMMARY

An embodiment of the present disclosure provides a resin infusion tooling system. The resin infusion tooling system comprises a heating tool bed comprising a plurality of cavities formed between a plurality of bed segments movable relative to each other, and a plurality of seals configured to seal the plurality of bed segments together for resin infusion of a plurality of dry stringer preforms in the plurality of cavities. The plurality of cavities is expandable by movement of the plurality of bed segments relative to each other.

Another embodiment of the present disclosure provides a resin infusion tooling system. The resin infusion tooling system comprises a heating tool bed comprising a plurality of cavities configured to support a plurality of dry stringer preforms during resin infusion, and a number of inserts configured to receive the plurality of dry stringer preforms and hold the plurality of dry stringer preforms within the plurality of cavities.

Yet another embodiment of the present disclosure provides a method of performing resin infusion. Blades of a plurality of dry stringer preforms are placed into a number of inserts. The blades of the plurality of dry stringer preforms are positioned within a plurality of cavities of a heating tool bed using the number of inserts. A panel preform is placed over the plurality of dry stringer preforms on the heating tool bed such that the panel preform is in contact with bases of the plurality of dry stringer preforms. A tool lid is sealed to the heating tool bed to form a resin infusion chamber. The plurality of dry stringer preforms and the panel preform are resin infused to form a reinforced panel.

A further embodiment of the present disclosure provides a method of performing resin infusion. Blades of a plurality of dry stringer preforms are placed into a number of inserts. The blades of the plurality of dry stringer preforms are positioned within a plurality of cavities of a heating tool bed using the number of inserts. A panel preform is placed over the plurality of dry stringer preforms on the heating tool bed such that the panel preform is in contact with bases of the plurality of dry stringer preforms. The plurality of dry stringer preforms and the panel preform are resin infused to form a reinforced panel. The reinforced panel is removed from the heating tool bed by removing the reinforced panel from the number of inserts.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and features thereof will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a cross-sectional view of a resin infusion tooling system comprising a heating tool bed with a plurality of bed segments in accordance with an illustrative embodiment;

FIG. 4 is an illustration of a cross-sectional view of a resin infusion tooling system in an open position in accordance with an illustrative embodiment;

FIG. 5 is an illustration of a cross-sectional view of a resin infusion tooling system receiving dry stringer preforms in accordance with an illustrative embodiment;

FIG. 6 is an illustration of a cross-sectional view of a resin infusion tooling system during resin infusion in accordance with an illustrative embodiment;

FIG. 7 is an illustration of an isometric view of a seal on a bed segment in accordance with an illustrative embodiment;

FIG. 8 is an illustration of a cross-sectional view of a resin infusion tooling system comprising a heating tool bed with a plurality of bed segments in accordance with an illustrative embodiment;

FIG. 9 is an illustration of a cross-sectional view of a resin infusion tooling system comprising a heating tool bed with a plurality of bed segments in accordance with an illustrative embodiment;

FIG. 10 is an illustration of a cross-sectional view of a resin infusion tooling system in an open position in accordance with an illustrative embodiment;

FIG. 11 is an illustration of a cross-sectional view of a resin infusion tooling system receiving dry stringer preforms in accordance with an illustrative embodiment;

FIG. 12 is an illustration of a cross-sectional view of a resin infusion tooling system during resin infusion in accordance with an illustrative embodiment;

FIG. 13 is an illustration of a cross-sectional view of a resin infusion tooling system while a reinforced panel is removed in accordance with an illustrative embodiment;

FIG. 14 is an illustration of a cross-sectional view of a resin infusion tooling system comprising a number of inserts in accordance with an illustrative embodiment;

FIG. 15 is an illustration of a cross-sectional view of a resin infusion tooling system comprising a number of inserts receiving dry stringer preforms in accordance with an illustrative embodiment;

FIG. 16 is an illustration of a cross-sectional view of a resin infusion tooling system during resin infusion in accordance with an illustrative embodiment;

FIG. 17 is an illustration of a cross-sectional view of a resin infusion tooling system comprising a number of inserts in accordance with an illustrative embodiment;

FIG. 18 is an illustration of a cross-sectional view of a resin infusion tooling system comprising a number of inserts in accordance with an illustrative embodiment;

FIG. 19 is an illustration of a cross-sectional view of a resin infusion tooling system comprising a number of inserts in accordance with an illustrative embodiment;

FIG. 20 is an illustration of a cross-sectional view of an insert of a resin infusion tooling system in accordance with an illustrative embodiment;

FIG. 21 is an illustration of a cross-sectional view of an insert of a resin infusion tooling system in accordance with an illustrative embodiment;

FIG. 22 is an illustration of a cross-sectional view of a resin infusion tooling system comprising a number of inserts in accordance with an illustrative embodiment;

FIG. 23 is an illustration of a cross-sectional view of a resin infusion tooling system comprising a number of inserts in accordance with an illustrative embodiment;

FIG. 24 is a flowchart of a method of performing resin infusion in accordance with an illustrative embodiment;

FIG. 25 is a flowchart of a method of performing resin infusion in accordance with an illustrative embodiment;

FIG. 26 is an illustration of an aircraft manufacturing and service method in a form of a block diagram in accordance with an illustrative embodiment; and

FIG. 27 is an illustration of an aircraft in a form of a block diagram in which an illustrative embodiment may be implemented.

### DETAILED DESCRIPTION

The illustrative examples recognize and take into account several considerations. The illustrative examples recognize and take into account that current automated high rate resin infusion processes have two sided net shape tooling for a structural panel with stringers. The illustrative examples recognize and take into account that conventional two-sided net shape tooling for a structural panel includes insertion of a dry fiber preform of the stringer into a narrow slot of a heated tool. The illustrative examples recognize and take into account that this insertion process has been shown to affect part quality and generate inconsistencies in the part. The illustrative examples recognize and take into account that the insertion process can cause tooling abrasion.

The illustrative examples recognize and take into account that existing methods to address the insertion process are to over consolidate stringer preforms. However, over-consolidation can cause volume fraction issues and resin flow issues. The illustrative examples recognize and take into account that existing methods to address the insertion process are to design a stringer slot with a larger slot and draft angle. However, a larger slot and draft angle could cause volume fraction issues and added post cure manufacturing process to remove excess resin.

The illustrative examples present a method for adjustable net part matched tooling for a gap resin infusion process of composites. Methods and tooling concepts are described in the illustrative examples that allow control and adjustability of tooling surfaces with complex geometry to be integrated into an automated high rate resin infusion process for sustainable composite structures.

The illustrative examples present control and adjustability of tooling surfaces. The control and adjustability of tooling surfaces provides flexibility of the tool to account for variability of dry fiber preform shape and automated placement tool tolerances to enable automated high-rate manufacturing of composites. Some of the illustrative examples present an adjustable tooling solution to open narrow tooling gaps prior to dry fiber preform insertion and close to net shape. In some illustrative examples, the cavities in the heating tool bed are expanded to receive the dry stringer preforms. In some illustrative examples, a number of inserts are provided. In some illustrative examples, the number of inserts receive the dry stringer preforms. In some illustrative examples, the number of inserts hold the dry stringer preforms in the plurality of cavities of the heating tool bed. In some illustrative examples, the number of inserts is opened to ease placement of the plurality of dry stringer preforms.

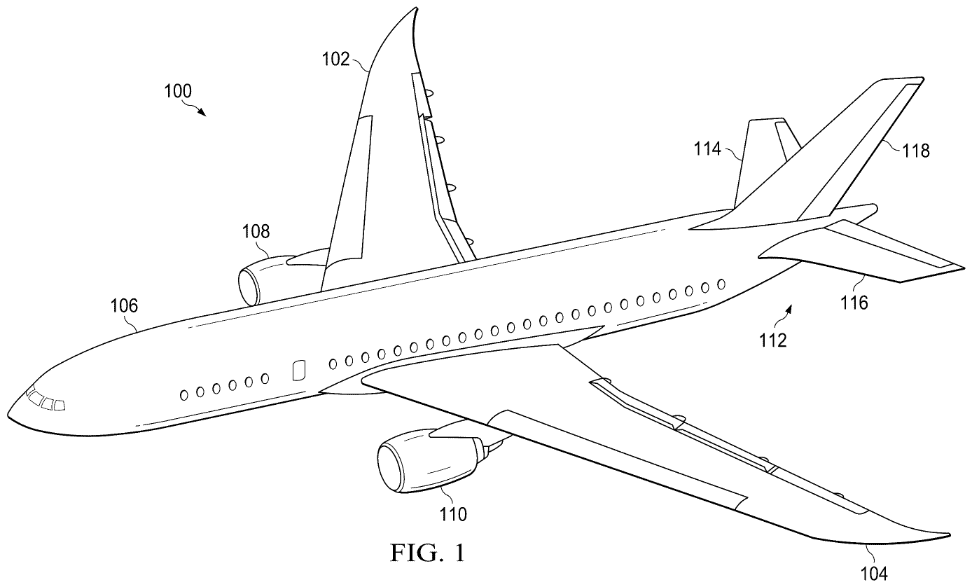

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft that can have reinforced composite panels manufactured according to the illustrative examples. Aircraft 100 is an example of an aircraft that can have resin infused parts formed using the illustrative examples.

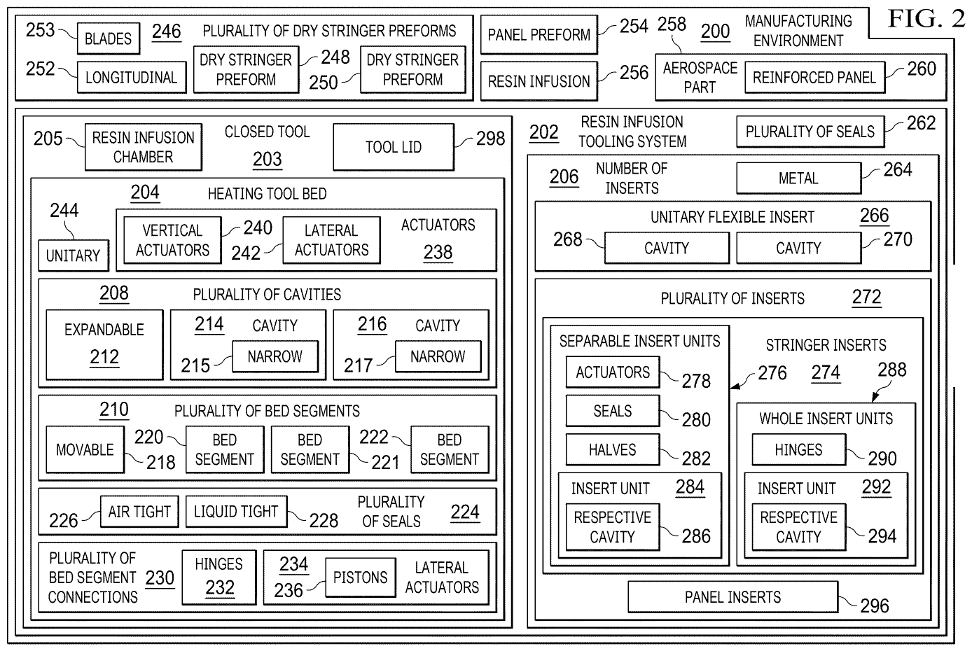

Turning now to FIG. 2, an illustration of a block diagram of a manufacturing environment is depicted in accordance with an illustrative embodiment. In manufacturing environment 200, resin infusion tooling system 202 is used to perform resin infusion 256 on panel preform 254 and plurality of dry stringer preforms 246 to form reinforced panel 260. Reinforced panel 260 can be a part of aircraft 100 of FIG. 1.

Resin infusion tooling system 202 comprises closed tool 203 with resin infusion chamber 205 formed by tool lid 298 and heating tool bed 204. Heating tool bed 204 comprises plurality of cavities 208 configured to receive plurality of dry stringer preforms 246. More specifically, plurality of cavities 208 is configured to receive blades 253 of plurality of dry stringer preforms 246. Plurality of dry stringer preforms 246 are longitudinal 252 components. As a result, blades 253 of plurality of dry stringer preforms 246 are very narrow compared to a length of plurality of dry stringer preforms 246. Plurality of cavities 208 at net shape are undesirably narrow for automated insertion of blades 253 of plurality of dry stringer preforms 246.

In some illustrative examples, panel preform 254 is placed into contact with bases of plurality of dry stringer preforms 246. When plurality of dry stringer preforms 246 has a T-shaped cross-section, the bases are opposite blades 253. When blades 253 are placed into plurality of cavities 208, blades 253 may be considered “facing down” while the bases are considered “facing up”.

In some illustrative examples, resin infusion tooling system 202 comprises heating tool bed 204 comprising plurality of cavities 208 formed between plurality of bed segments 210 movable relative to each other, and plurality of seals 224 configured to seal plurality of bed segments 210 together for resin infusion 256 of plurality of dry stringer preforms 246 in plurality of cavities 208. In some illustrative examples, plurality of cavities 208 is expandable 212 by movement of plurality of bed segments 210 relative to each other.

When plurality of bed segments 210 are movable 218, plurality of bed segments 210 are connected by plurality of bed segment connections 230. In some illustrative examples, plurality of bed segments 210 are movable 218 in a single axis. In some illustrative examples, resin infusion tooling system 202 comprises lateral actuators 234 configured to move plurality of bed segments 210 laterally relative to each other. In some illustrative examples, plurality of bed segments 210 are movable 218 laterally by lateral actuators 234. In some illustrative examples, lateral actuators 234 comprise pistons 236.

In some illustrative examples, plurality of bed segments 210 are movable 218 in more than one axis. In some of these illustrative examples, resin infusion tooling system 202 comprises hinges 232 connecting plurality of bed segments 210 to enable fanning movement of plurality of bed segments 210 relative to each other.

To place plurality of dry stringer preforms 246 into plurality of cavities 208 when plurality of cavities 208 is expandable 212, plurality of bed segments 210 are initially moved away from each other.

In this illustrative example, plurality of bed segments 210 comprises bed segment 220, bed segment 221, and bed segment 222. Cavity 214 is formed between bed segment 220 and bed segment 221. Cavity 216 is formed between bed segment 221 and bed segment 222. Cavity 214 is narrow 215 in a net shape prior to expansion. Cavity 216 is narrow 217 in a net shape prior to expansion.

In this illustrative example, dry stringer preform 248 will be placed into cavity 214. In this illustrative example, dry stringer preform 250 will be placed into cavity 216.

After receiving plurality of dry stringer preforms 246 in plurality of cavities 208, plurality of bed segments 210 is moved towards each other. Moving plurality of bed segments 210 towards each other decreases the size of plurality of cavities 208. Moving plurality of bed segments 210 towards each other seals plurality of bed segments 210 to each other using plurality of seals 224. Plurality of seals 224 are both airtight 226 and liquid tight 228 to allow for pulling a vacuum and for resin infusion 256.

Utilizing closed tool 203 comprising plurality of bed segments 210 and plurality of seals 224 generates aerospace part 258 having a desired quality of resin infusion 256. Plurality of seals 224 enables use of plurality of bed segments 210 to create expandable 212 plurality of cavities 208.

In some illustrative examples, resin infusion tooling system 202 comprises number of inserts 206 configured to receive plurality of dry stringer preforms 246 and hold plurality of dry stringer preforms 246 within plurality of cavities 208. Number of inserts 206 can comprise any desirable quantity of inserts. In this illustrative example, number of inserts 206 is used in conjunction with expandable 212 plurality of cavities 208. In some illustrative examples, actuators 238 are present to actuate number of inserts 206 relative to heating tool bed 204. In some illustrative examples, actuators 238 comprise at least one of vertical actuators 240 or lateral actuators 242 to move number of inserts 206 relative to plurality of bed segments 210. In some illustrative examples, actuators 238 can be used to expand cavities of number of inserts 206. In some illustrative examples, actuators 238 can be used to lift number of inserts 206 away from heating tool bed 204.

In some illustrative examples, resin infusion tooling system 202 comprises heating tool bed 204 comprising plurality of cavities 208 configured to support plurality of dry stringer preforms 246 during resin infusion 256, and number of inserts 206 configured to receive plurality of dry stringer preforms 246 and hold plurality of dry stringer preforms 246 within plurality of cavities 208. Number of inserts 206 comprises any quantity of inserts. In some illustrative examples, number of inserts 206 comprises unitary flexible insert 266. In this illustrative example, unitary flexible insert 266 comprises cavity 268 and cavity 270 configured to receive dry stringer preform 248 and dry stringer preform 250. In these illustrative examples, portion of unitary flexible insert 266 with cavity 268 is placed into cavity 214 and portion of unitary flexible insert 266 with cavity 270 is placed into cavity 216. In some illustrative examples, number of inserts 206 comprises unitary flexible insert 266 with cavities configured to slide into plurality of cavities 208 of heating tool bed 204.

In some illustrative examples, number of inserts 206 comprises plurality of inserts 272 comprising stringer inserts 274. In some illustrative examples, each insert unit of stringer inserts 274 has a respective cavity configured to receive a dry stringer preform of plurality of dry stringer preforms 246. In some illustrative examples, stringer inserts 274 comprises separable insert units 276. In some illustrative examples, separable insert units 276 comprise actuators 278 to move halves 282 of separable insert units 276 relative to each other. By actuating a separable insert unit of separable insert units 276, the two halves of the respective separable insert unit are moved towards or away from each other. Seals 280 are present to seal halves 282 of separable insert units 276 to enable resin infusion 256.

For example, insert unit 284 comprises respective cavity 286. Respective cavity 286 is expandable by moving halves 282 of insert unit 284 away from each other. Seals 280 seal halves 282 of insert unit 284 together. In this illustrative example, stringer inserts 274 comprise separable insert units 276 with halves 282 separable from each other.

In some illustrative examples, stringer inserts 274 comprise whole insert units 288 with respective cavities expandable by hinges 290. For example, insert unit 292 comprises respective cavity 294 expandable by a hinge of hinges 290. In some illustrative examples, stringer inserts 274 comprise whole insert units 288 expandable by the flexible material forming whole insert units 288.

In some illustrative examples, plurality of inserts 272 further comprises panel inserts 296. In these illustrative examples, panel inserts 296 are positioned between stringer inserts 274. In some illustrative examples, each stringer insert 274 is independently actuated relative to heating tool bed 204 by actuators 238. In some illustrative examples, each panel insert of panel inserts 296 is independently actuated using actuators 238 relative to heating tool bed 204. In some illustrative examples, plurality of inserts comprise panel inserts 296 positioned between stringer inserts 274 and configured to support panel preform 254 positioned over stringer inserts 274 and panel inserts 296.

In some illustrative examples, plurality of seals 262 is present in resin infusion tooling system 202 to seal number of inserts 206 to each other. In some illustrative examples, plurality of seals 262 is present in resin infusion tooling system 202 to seal number of inserts 206 to heating tool bed 204.

In some illustrative examples, number of inserts 206 are used in conjunction with unitary 244 heating tool bed 204. In some illustrative examples, unitary 244 heating tool bed 204 comprises a single non-moving bed. In some illustrative examples, plurality of cavities 208 are non-net shape and rigid. In some illustrative examples, plurality of cavities 208 are sized to receive number of inserts 206 so that cavities in number of inserts 206 are net shape when inserted into plurality of cavities 208. In some illustrative examples, plurality of cavities 208 are expandable 212 and number of inserts 206 adjustable so that cavities in number of inserts 206 are net shape when inserted into plurality of cavities 208.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, plurality of cavities 208 can include more than two cavities. As another example, plurality of seals 224 can include any desirable quantity and positioning of seals. In some illustrative examples, plurality of seals 224 can include unitary seals that extend to seal tool lid 298 to a bed segment and seal multiple bed segments to each other.

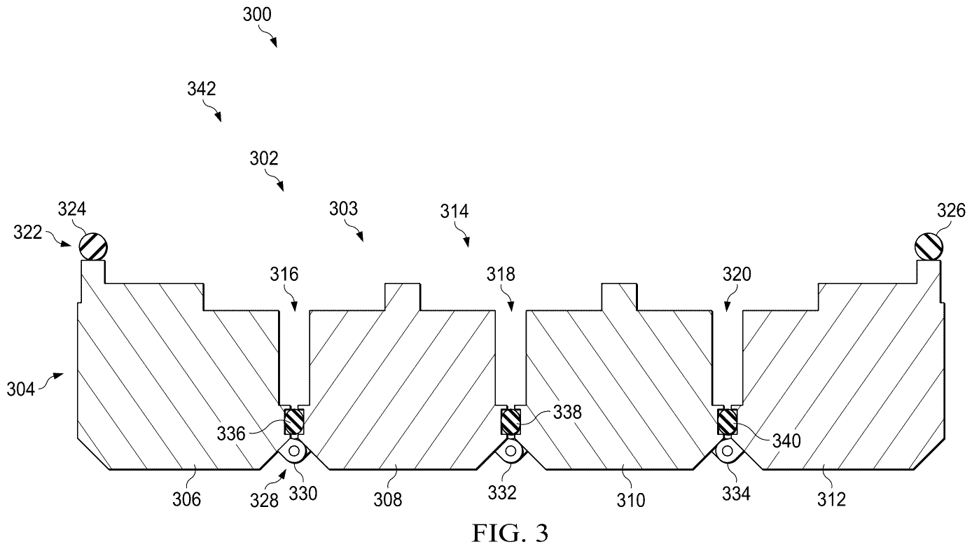

Turning now to FIG. 3, an illustration of a cross-sectional view of a resin infusion tooling system comprising a heating tool bed with a plurality of bed segments is depicted in accordance with an illustrative embodiment.

Portions of resin infusion tooling system 302 are depicted in view 300. Resin infusion tooling system 302 comprises heating tool bed 303. Heating tool bed 303 comprises plurality of bed segments 304. In this illustrative example, plurality of bed segments 304 comprises bed segment 306, bed segment 308, bed segment 310, and bed segment 312. Plurality of cavities 314 is formed by plurality of bed segments 304. Plurality of cavities 314 comprises cavity 316, cavity 318, and cavity 320.

Plurality of seals 322 is present in resin infusion tooling system 302 to cause heating tool bed 303 to be airtight and liquid tight for resin infusion. Plurality of seals 322 comprises seal 324 and seal 326 configured to seal plurality of bed segments 304 to a tooling lid. Plurality of seals 322 comprises seal 336, seal 338, and seal 340 configured to seal plurality of bed segments 304 to each other. In some illustrative examples, a unitary seal can form portions of a seal between plurality of bed segments 304 and the tooling lid. For example, in some illustrative examples, a unitary seal can form portions of seal 324 and seal 336. In one illustrative example, a unitary seal can form portions of seal 326 and seal 340.

Plurality of bed segments 304 are configured to move relative to each other to adjust plurality of cavities 314. In this illustrative example, plurality of bed segments 304 is connected by plurality of hinges 328. Plurality of hinges 328 comprises hinge 330, hinge 332, and hinge 334. Hinge 330 connects bed segment 306 and bed segment 308. Hinge 332 connects bed segment 308 and bed segment 310. Hinge 334 connects bed segment 310 and bed segment 312. Plurality of hinges 328 enable movement of plurality of bed segments 304 in a plurality of axes. Plurality of hinges 328 enable movement of plurality of bed segments 304 in a fan-like motion.

In view 300, plurality of bed segments 304 are in closed configuration 342. In this illustrative example, closed configuration 342 provides plurality of cavities 314 with a net shape.

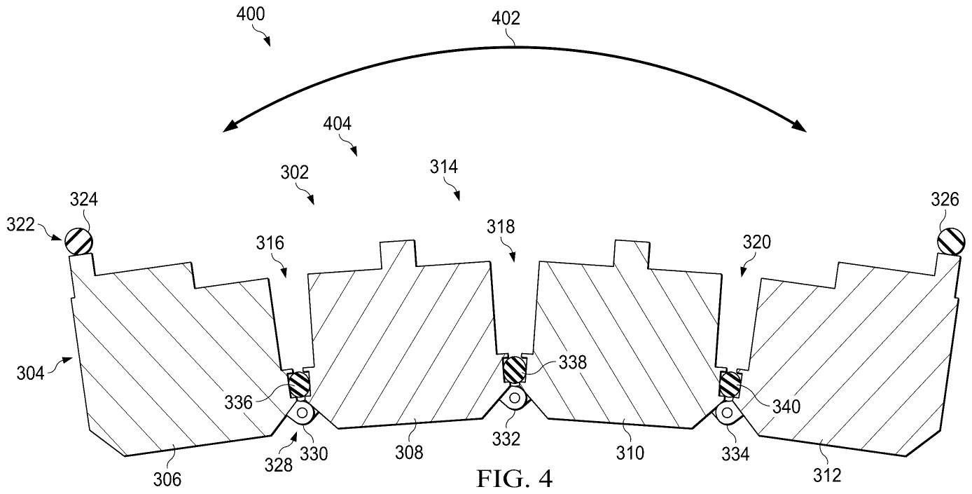

Turning now to FIG. 4, an illustration of a cross-sectional view of a resin infusion tooling system in an open position is depicted in accordance with an illustrative embodiment. In view 400, plurality of bed segments 304 have moved in fan movement 402. By moving plurality of bed segments 304 in fan movement 402, heating tool bed 303 is in open configuration 404. In open configuration 404 plurality of cavities 314 has expanded from closed configuration 342 of view 300. Each of cavity 316, cavity 318, and cavity 320 has expanded to more easily receive a respective dry stringer preform.

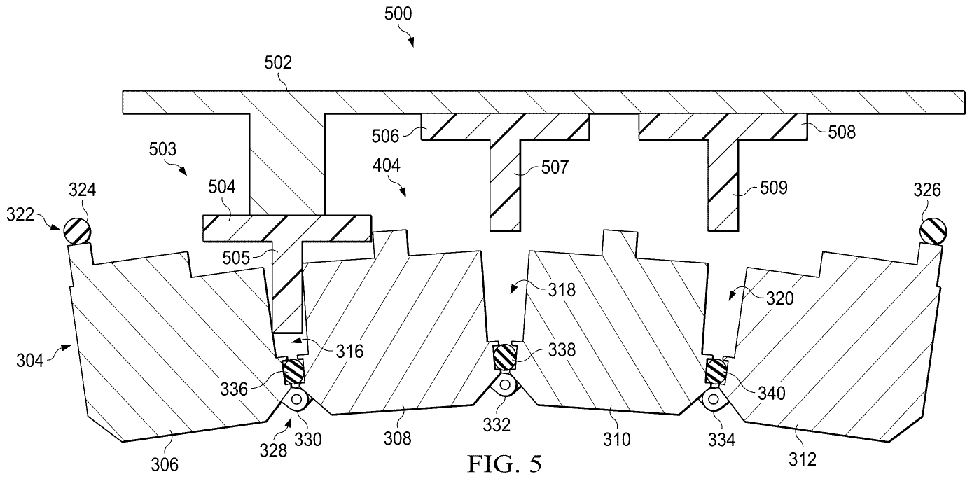

Turning now to FIG. 5, an illustration of a cross-sectional view of a resin infusion tooling system receiving dry stringer preforms is depicted in accordance with an illustrative embodiment. In view 500, plurality of bed segments 304 is in open configuration 404 and plurality of dry stringer preforms 503 is being placed into plurality of cavities 314. In this illustrative example, blade 505 of dry stringer preform 504 is being placed into cavity 316. In this illustrative example, blade 507 of dry stringer preform 506 is positioned to be placed into cavity 318. In this illustrative example, blade 509 of dry stringer preform 508 is positioned to be placed into cavity 320.

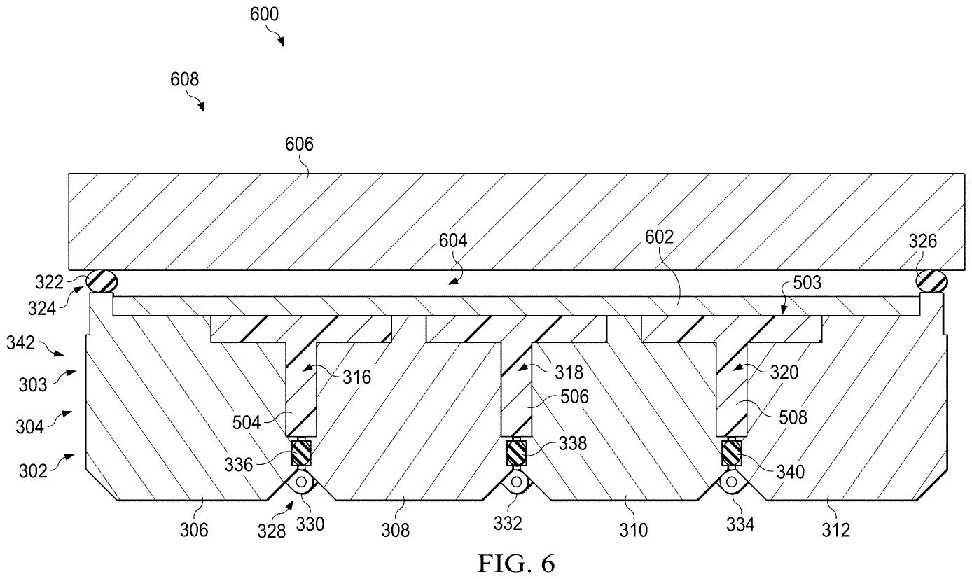

Turning now to FIG. 6, an illustration of a cross-sectional view of a resin infusion tooling system during resin infusion is depicted in accordance with an illustrative embodiment. In view 600, resin infusion is being performed on plurality of dry stringer preforms 503. Panel preform 602 is positioned over and in contact with plurality of dry stringer preforms 503.

Tool lid 606 is sealed to heating tool bed 303 by seal 324 and seal 326. Sealing tool lid 606 to heating tool bed 303 forms resin infusion chamber 604. Resin infusion chamber 604 contains panel preform 602 and plurality of dry stringer preforms 503. By resin infusing panel preform 602 and plurality of dry stringer preforms 503, a reinforced panel is formed.

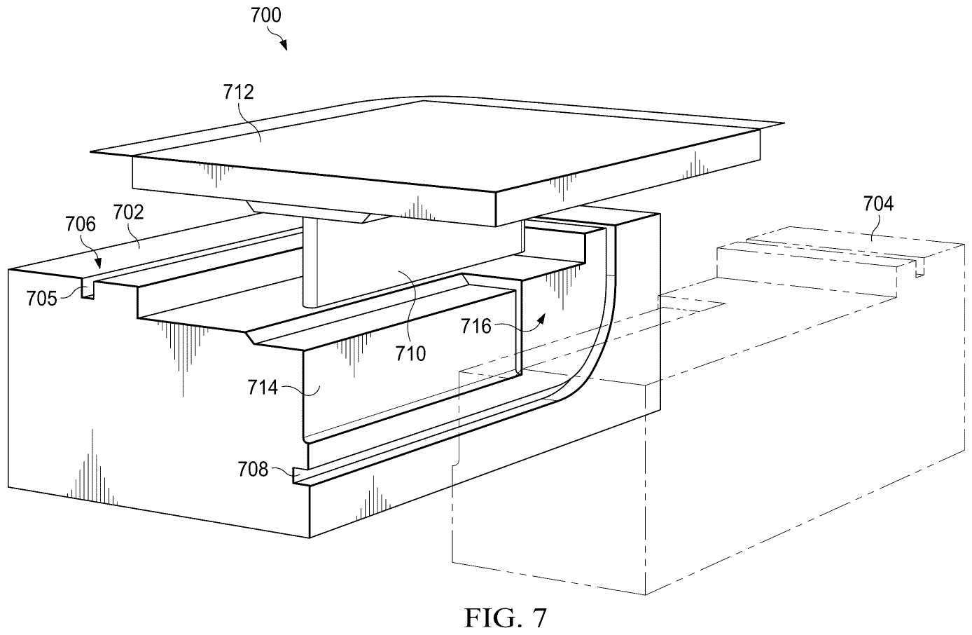

Turning now to FIG. 7, an illustration of an isometric view of a seal on a bed segment is depicted in accordance with an illustrative embodiment. View 700 is an isometric view of bed segment 702 and bed segment 704. Bed segment 702 and bed segment 704 will be moved towards each other to form a net shape cavity to process dry stringer preform 710. Seal groove 705 is visible in view 700. A seal will be placed into seal groove 705 prior to processing. Seal groove 705 comprises top seal region 706 and cavity seal region 708. Top seal region 706 will seal a tool lid against bed segment 702. Cavity seal region 708 will seal bed segment 702 to bed segment 704. Cavity seal region 708 extends below net shape surface 714 which will form part of the net shape cavity between bed segment 702 and bed segment 704. Net shape surface 714 will contact a blade of dry stringer preform 710.

Flash region 716 is positioned between net shape surface 714 and seal groove 705. A difference between flash region 716 and net shape surface 714 is sufficient to maintain the flash on the reinforced panel product. The flash present on the reinforced panel will be removed in post processing. Having sufficiently sized flash to remain on the reinforced panel can mitigate breakage or debris left in the tool due to flash after reinforced panel removal.

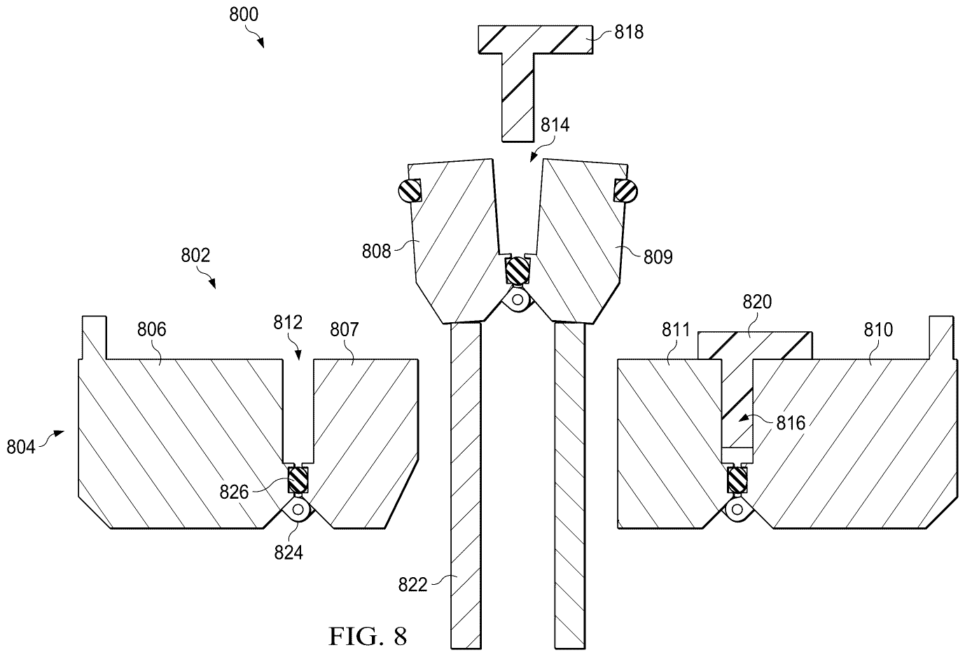

Turning now to FIG. 8, an illustration of a cross-sectional view of a resin infusion tooling system comprising a heating tool bed with a plurality of bed segments is depicted in accordance with an illustrative embodiment. In view 800, plurality of bed segments 804 of heating tool bed 802 are actuated relative to each other to receive dry stringer preforms. Plurality of bed segments 804 comprises bed segment 806, bed segment 807, bed segment 808, bed segment 809, bed segment 810, and bed segment 811. In this illustrative example, a blade of dry stringer preform 820 is present in cavity 816 between bed segment 810 and bed segment 811. In this illustrative example, each respective bed segment is hinged to another bed segment to allow for expansion of a respective cavity. Hinges 824 enable movement of bed segment 806 relative to bed segment 807. Hinges 824 enable movement of bed segment 808 relative to bed segment 809. Hinges 824 enable movement of bed segment 810 relative to bed segment 811. In view 800, bed segments are moved vertically relative to each other to allow for space to open respective cavities. In view 800, bed segment 808 and bed segment 809 have been moved vertically by actuators 822 to enable opening cavity 814 to receive dry stringer preform 818. In this illustrative example, cavity 812 is in net shape and has not yet received a dry stringer preform. After dry stringer preform 818 is placed into cavity 814, bed segment 806 and bed segment 807 will be actuated to expand cavity 812 to receive a dry stringer preform.

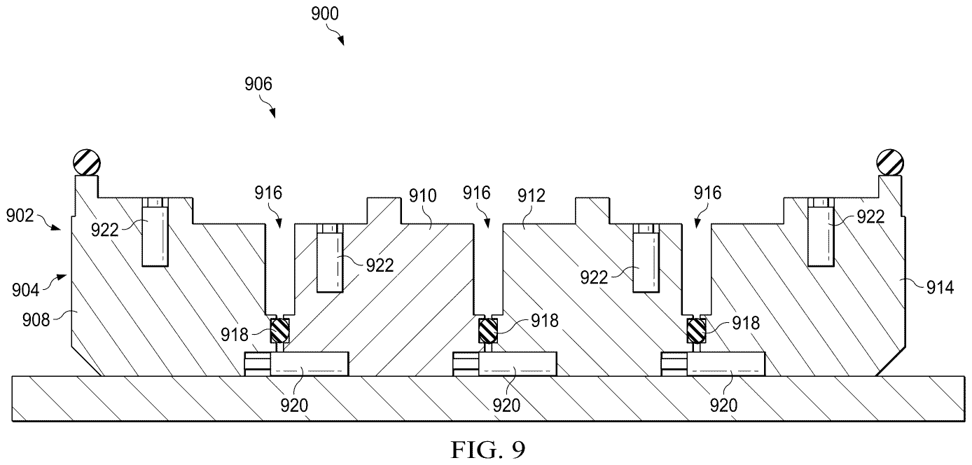

Turning now to FIG. 9, an illustration of a cross-sectional view of a resin infusion tooling system comprising a heating tool bed with a plurality of bed segments is depicted in accordance with an illustrative embodiment. Resin infusion tooling system 906 is a physical implementation of resin infusion tooling system 202 of FIG. 2. In view 900, heating tool bed 902 comprises plurality of bed segments 904. Plurality of bed segments 904 comprise bed segment 908, bed segment 910, bed segment 912, and bed segment 914 that are laterally movable relative to each other. In view 900, plurality of bed segments 904 are in a closed position. In the closed position, plurality of cavities 916 have a net shape for an aerospace part. In this illustrative example, plurality of seals 918 are present to seal plurality of bed segments 904 to each other and to a tool lid. In this illustrative example, lateral actuators 920 are present. Lateral actuators 920 enable movement of plurality of bed segments 904 relative to each other. Lateral actuators 920 enable movement of plurality of bed segments 904 to place heating tool bed 902 into an open position. Lateral actuators 920 enable movement of plurality of bed segments 904 to expand plurality of cavities 916 into an open position.

In this illustrative example, vertical actuators 922 are present in plurality of bed segments 904. Vertical actuators 922 are provided to enable removal of a reinforced panel after resin infusing dry preforms.

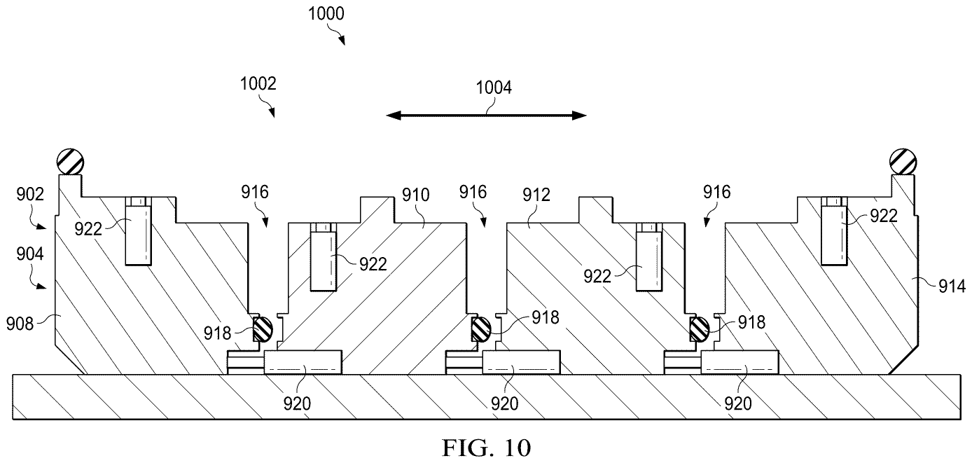

Turning now to FIG. 10, an illustration of a cross-sectional view of a resin infusion tooling system in an open position is depicted in accordance with an illustrative embodiment. In view 1000, lateral actuators 920 have moved plurality of bed segments 904 in direction 1004 to place plurality of bed segments 904 in open position 1002. Plurality of cavities 916 are expanded in open position 1002 in view 1000.

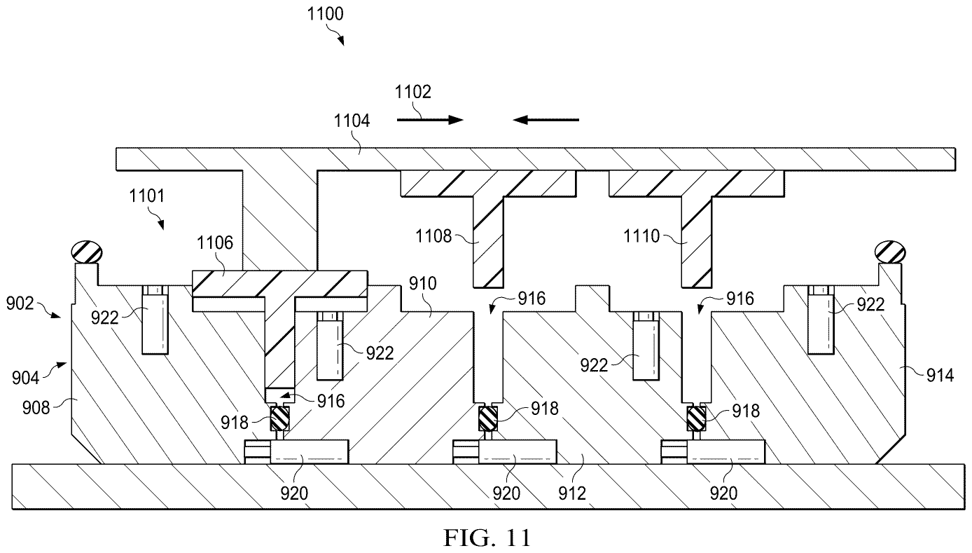

Turning now to FIG. 11, an illustration of a cross-sectional view of a resin infusion tooling system receiving dry stringer preforms is depicted in accordance with an illustrative embodiment. In view 1100, pick and place tool 1104 is placing plurality of dry stringer preforms 1101 into plurality of cavities 916. In view 1100, dry stringer preform 1106 has been placed into a respective cavity of plurality of cavities 916. After placing dry stringer preform 1106 into the respective cavity, a lateral actuator is used to move at least one of bed segment 908 or bed segment 910 relative to the other in direction 1102 to contract the respective cavity to a net shape.

In view 1100, dry stringer preform 1108 and dry stringer preform 1110 have not yet been placed into respective cavities. In view 1100, the cavities to receive dry stringer preform 1108 and dry stringer preform 1110 are still expanded.

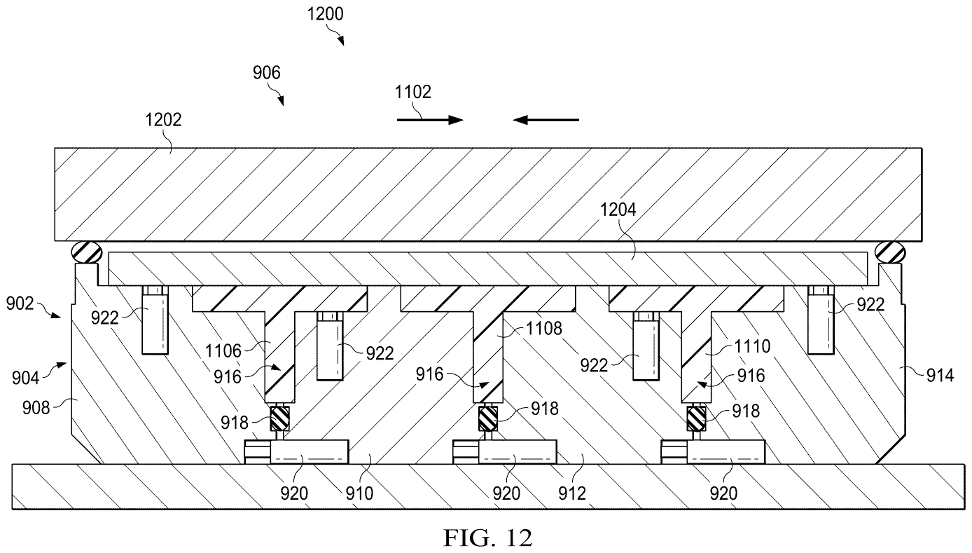

Turning now to FIG. 12, an illustration of a cross-sectional view of a resin infusion tooling system during resin infusion is depicted in accordance with an illustrative embodiment. In view 1200, dry stringer preform 1108 and dry stringer preform 1110 have been positioned in respective cavities. Plurality of cavities 916 have been contracted to a net shape. Panel preform 1204 has been positioned over plurality of dry stringer preforms 1101 and heating tool bed 902. Tool lid 1202 has been sealed to heating tool bed 902 to form a closed tool for performing resin infusion. In view 1200, resin infusion is performed on panel preform 1204 and plurality of dry stringer preforms 1101.

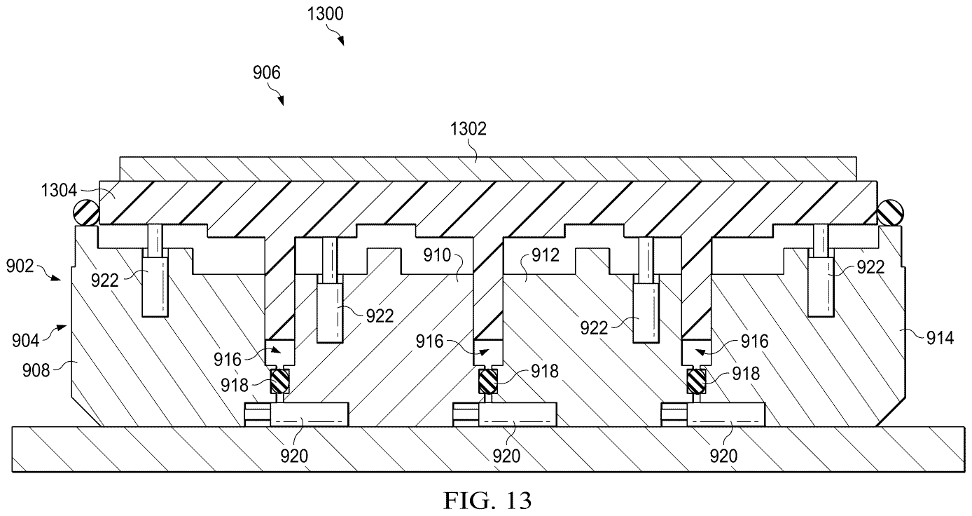

Turning now to FIG. 13, an illustration of a cross-sectional view of a resin infusion tooling system while a reinforced panel is removed is depicted in accordance with an illustrative embodiment. In view 1300, resin infusion has been completed and tool lid 1202 has been removed. Pick and place tool 1302 is present to remove reinforced panel 1304 from resin infusion tooling system 906. Additionally, vertical actuators 922 are used to lift reinforced panel 1304 away from heating tool bed 902. In some illustrative examples, vertical actuators 922 are used to lift reinforced panel 1304 prior to lifting using pick and place tool 1302. In some illustrative examples, vertical actuators 922 are used to lift reinforced panel 1304 substantially simultaneously to lifting using pick and place tool 1302.

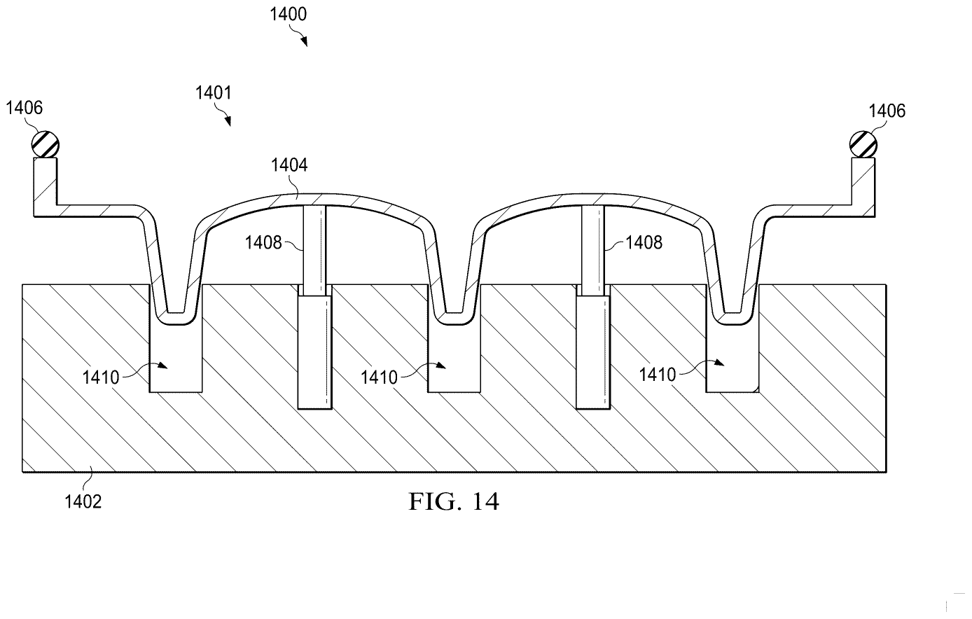

Turning now to FIG. 14, an illustration of a cross-sectional view of a resin infusion tooling system comprising a number of inserts is depicted in accordance with an illustrative embodiment. Resin infusion tooling system 1401 is a physical implementation of resin infusion tooling system 202 of FIG. 2.

Resin infusion tooling system 1401 comprises number of inserts 1404 and heating tool bed 1402. In this illustrative example, heating tool bed 1402 is a unitary tool bed. In this illustrative example, plurality of cavities 1410 in heating tool bed 1402 maintain a size and shape.

Number of inserts 1404 comprises a unitary flexible insert. The unitary flexible insert comprises a material that can bend and flex to be inserted into plurality of cavities 1410. In some illustrative examples, number of inserts 1404 comprises a flexible metal material. Plurality of seals 1406 are present on number of inserts 1404. Plurality of seals 1406 are used to seal number of inserts 1404 to a tool lid for resin infusion.

In this illustrative example, vertical actuators 1408 are present in heating tool bed 1402. Vertical actuators 1408 are configured to move number of inserts 1404 relative to heating tool bed 1402. In some illustrative examples, vertical actuators 1408 are used to hold number of inserts 1404 above heating tool bed 1402 to receive dry stringer preforms. In some illustrative examples, vertical actuators 1408 are used to lift number of inserts 1404 out of plurality of cavities 1410 after a reinforced panel is removed from resin infusion tooling system 1401.

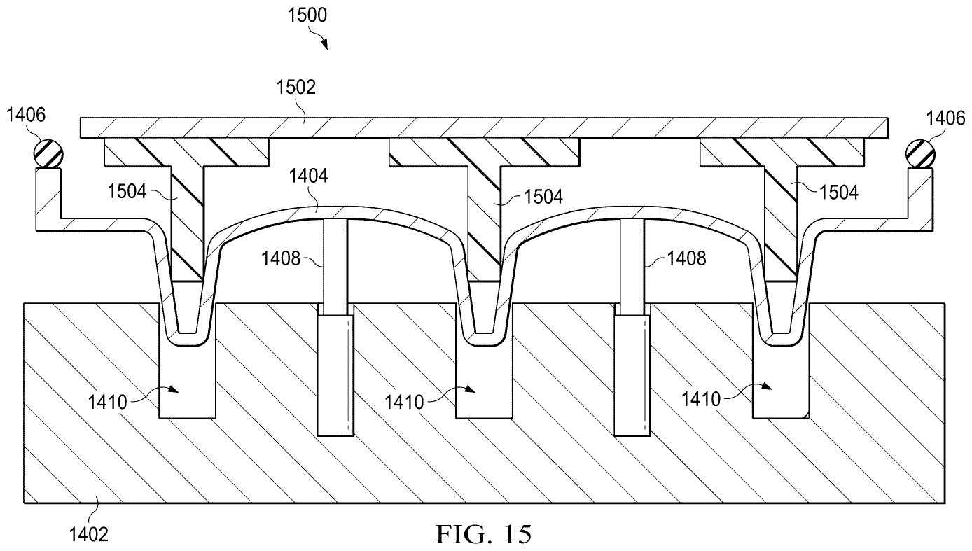

Turning now to FIG. 15, an illustration of a cross-sectional view of a resin infusion tooling system comprising a number of inserts receiving dry stringer preforms is depicted in accordance with an illustrative embodiment. In view 1500, pick and place tool 1502 is simultaneously placing plurality of dry stringer preforms 1504 into cavities of number of inserts 1404. In this illustrative example, vertical actuators 1408 hold number of inserts 1404 above heating tool bed 1402.

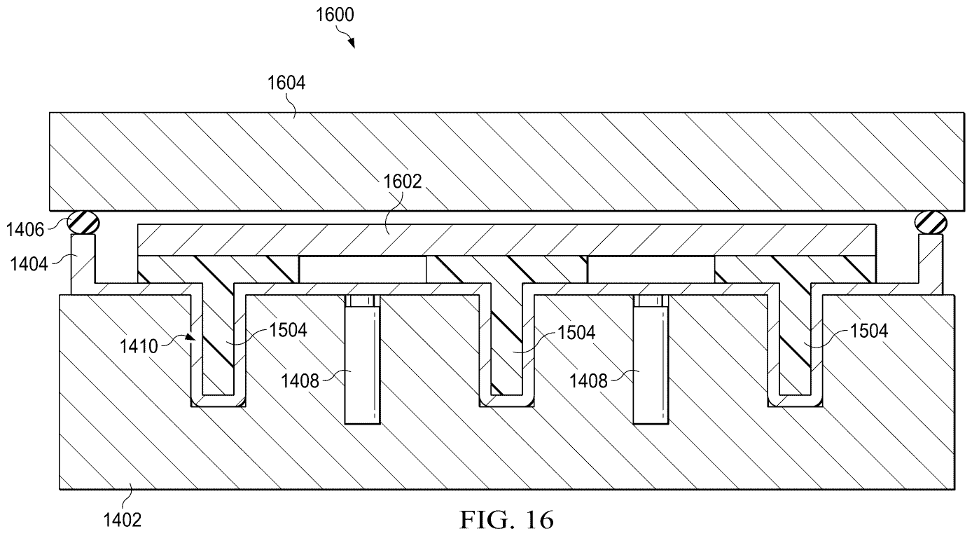

Turning now to FIG. 16, an illustration of a cross-sectional view of a resin infusion tooling system during resin infusion is depicted in accordance with an illustrative embodiment. In view 1600, vertical actuators 1408 have been lowered and number of inserts 1404 has been inserted into plurality of cavities 1410. Plurality of dry stringer preforms 1504 are present in cavities of number of inserts 1404. Number of inserts 1404 hold plurality of dry stringer preforms 1504 in plurality of cavities 1410. In view 1600, panel preform 1602 is present over plurality of dry stringer preforms 1504.

Tool lid 1604 has been sealed to number of inserts 1404 using plurality of seals 1406. Sealing tool lid 1604 to number of inserts 1404 forms a resin infusion chamber containing plurality of dry stringer preforms 1504 and panel preform 1602.

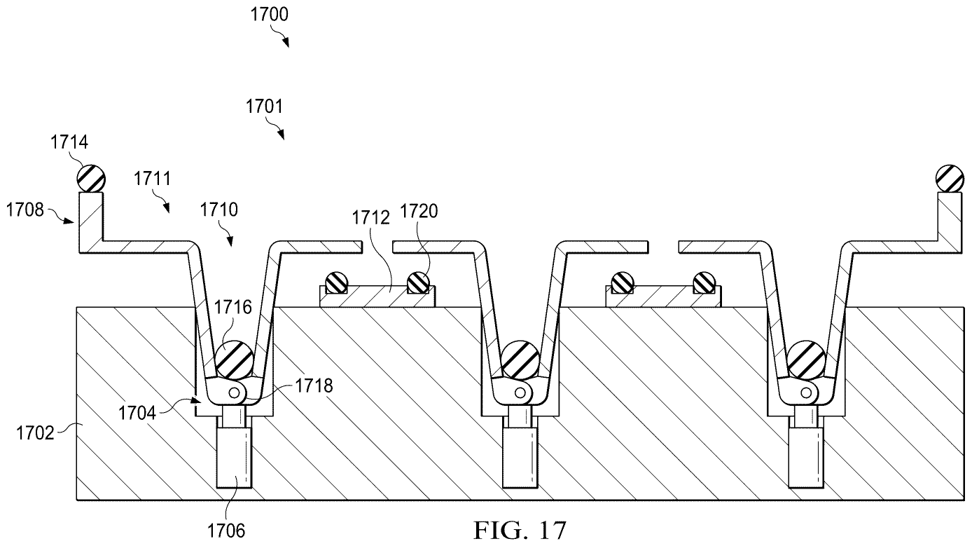

Turning now to FIG. 17, an illustration of a cross-sectional view of a resin infusion tooling system comprising a number of inserts is depicted in accordance with an illustrative embodiment. Resin infusion tooling system 1701 is a physical implementation of resin infusion tooling system 202 of FIG. 2.

In view 1700, resin infusion tooling system 1701 comprises a heating tool bed 1702 comprising plurality of cavities 1704 and plurality of vertical actuators 1706. Plurality of vertical actuators 1706 are configured to lift plurality of inserts 1708 to open plurality of cavities 1710 of stringer inserts 1711. In this illustrative example, plurality of inserts 1708 comprises stringer inserts 1711 and panel inserts 1712.

Stringer inserts 1711 are independently movable relative to each other. Stringer inserts 1711 are movable independently of panel inserts 1712. Vertical actuators 1706 are used to independently move stringer inserts 1711 to receive dry stringer preforms and place the dry stringer preforms into plurality of cavities 1704. Each of stringer inserts 1711 comprises a hinge of hinges 1718. Hinges 1718 enable expansion of plurality of cavities 1710 of stringer inserts 1711. Plurality of seals 1716 seal stringer inserts 1711 when inserted into plurality of cavities 1704. Plurality of seals 1720 seal stringer inserts 1711 to panel inserts 1712. Seals 1714 are configured to seal plurality of inserts 1708 to a tool lid to form a closed tool.

In resin infusion tooling system 1701, plurality of inserts 1708 remain associated with heating tool bed 1702. Stringer inserts 1711 are movable relative to heating tool bed 1702 but remain associated with plurality of cavities 1704.

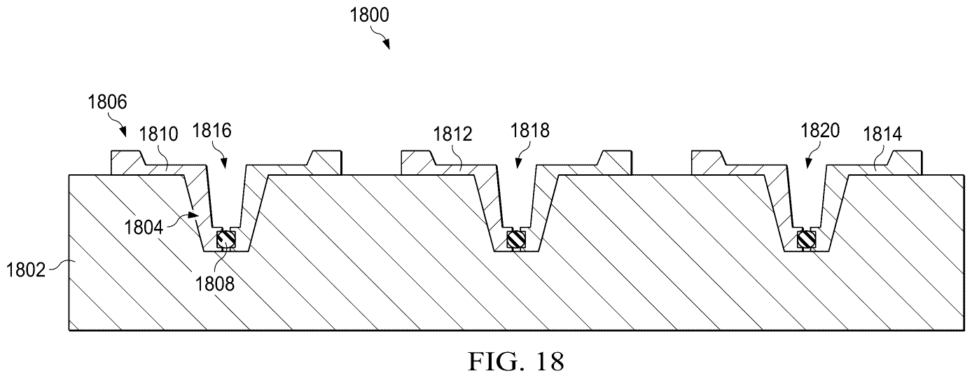

Turning now to FIG. 18, an illustration of a cross-sectional view of a resin infusion tooling system comprising a number of inserts is depicted in accordance with an illustrative embodiment. Number of inserts 1806 can be a physical implementation of number of inserts 206 of FIG. 2.

In this illustrative example, number of inserts 1806 is present on a separate forming tool 1802. Forming tool 1802 is separate from a heating tool bed for resin infusion. Forming tool 1802 is present for number of inserts 1806 to receive a plurality of dry stringer preforms. In this illustrative example, number of inserts 1806 comprises stringer insert 1810 with cavity 1816, stringer insert 1812 with cavity 1818, and stringer insert 1814 with cavity 1820. In this illustrative example, cavity 1816, cavity 1818, and cavity 1820 are expanded. In this illustrative example, each of stringer insert 1810, stringer insert 1812, and stringer insert 1814 comprise halves separated in view 1800. Seals 1808 are present on number of inserts 1806. Seals 1808 are positioned to seal together respective halves of stringer insert 1810, stringer insert 1812, and stringer insert 1814 during resin infusion.

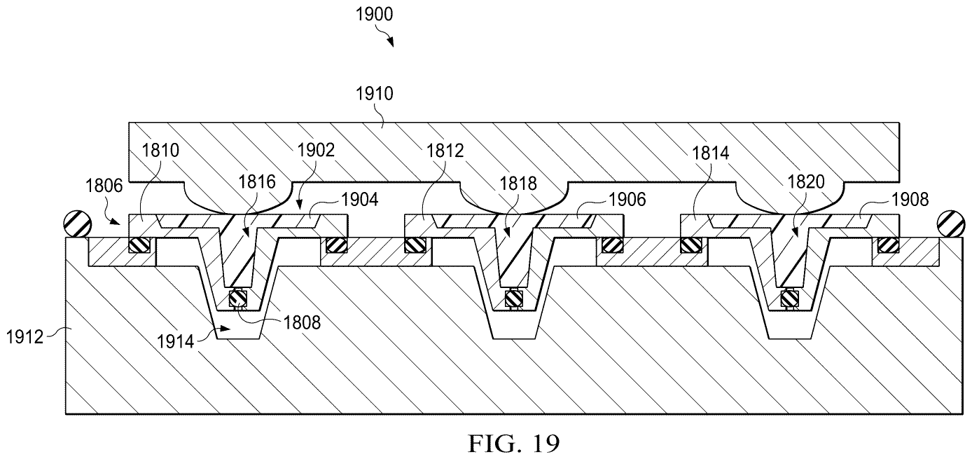

Turning now to FIG. 19, an illustration of a cross-sectional view of a resin infusion tooling system comprising a number of inserts is depicted in accordance with an illustrative embodiment. View 1900 is a view of number of inserts 1806 on heating tool bed 1912 during resin infusion. In view 1900, plurality of dry stringer preforms 1902 have been inserted into number of inserts 1806 while number of inserts 1806 were on separate forming tool 1802. In this illustrative example, blade of dry stringer preform 1904 is present in cavity 1816. In this illustrative example, blade of dry stringer preform 1906 is present in cavity 1818. In this illustrative example, blade of dry stringer preform 1908 is present in cavity 1820. In this illustrative example, number of inserts 1806 are closed such that seals 1808 seal number of inserts 1806 together for resin infusion. In this illustrative example, pick and place tool 1910 picks and places plurality of dry stringer preforms 1902 and number of inserts 1806 together to place number of inserts into plurality of cavities 1914 of heating tool bed 1912. Heating tool bed 1912 is used for resin infusion of plurality of dry stringer preforms 1902.

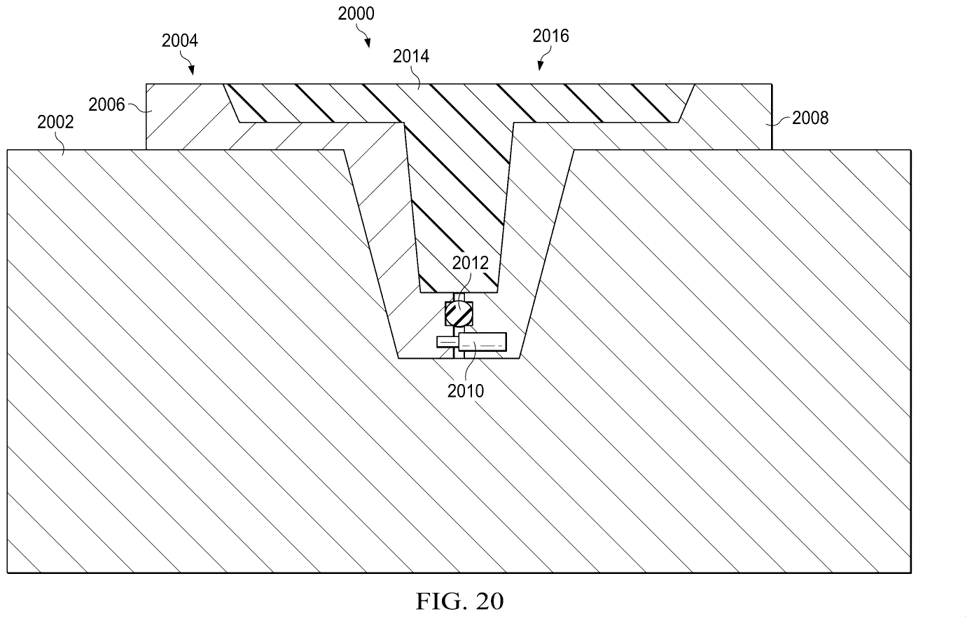

Turning now to FIG. 20, an illustration of a cross-sectional view of an insert of a resin infusion tooling system is depicted in accordance with an illustrative embodiment. Stringer insert 2004 can be a physical implementation of number of inserts 206 of FIG. 2. In view 2000, a possible actuation method for stringer insert 2004 is discussed. The actuation described in view 2000 may be used in number of inserts 1806 of FIGS. 18 and 19.

In view 2000, separate forming tool 2002 supports stringer insert 2004. Stringer insert 2004 comprises half 2006 and half 2008 movable relative to each other. In this illustrative example, dry stringer preform 2014 is present in cavity 2016 in stringer insert 2004.

Stringer insert 2004 comprises lateral actuator 2010 and seal 2012. In this illustrative example, stringer insert 2004 can be moved in any desirable fashion so that lateral actuator 2010 expands cavity 2016 of stringer insert 2004. Seal 2012 seals half 2006 to half 2008 for resin infusion of dry stringer preform 2014.

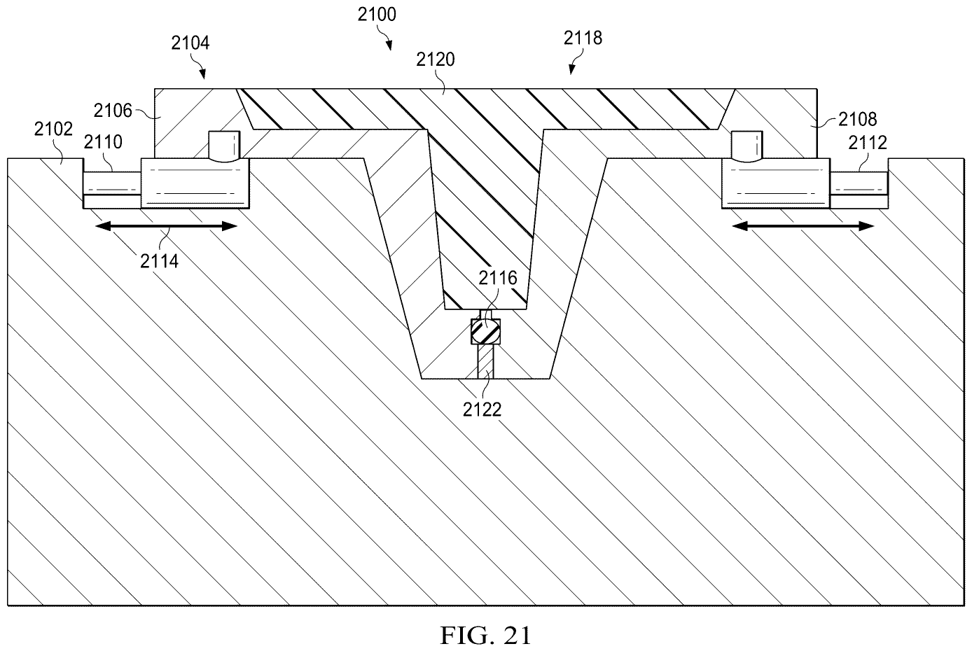

Turning now to FIG. 21, an illustration of a cross-sectional view of an insert of a resin infusion tooling system is depicted in accordance with an illustrative embodiment. Stringer insert 2104 can be a physical implementation of one insert of plurality of inserts 272 of FIG. 2. In view 2100, a possible actuation method for stringer insert 2104 is discussed. The actuation described in view 2100 may be used in number of inserts 1806 of FIGS. 18 and 19.

In view 2100, forming tool 2102 supports stringer insert 2104. Stringer insert 2104 comprises half 2106 and half 2108. Actuators are present in forming tool 2102 to actuate stringer insert 2104 to expand or contract cavity 2118. In this illustrative example, actuator 2110 is connected to forming tool 2102. Actuator 2110 is configured to move half 2106 of stringer insert 2104. Actuator 2112 is configured to move half 2108 of stringer insert 2104. Actuator 2110 and actuator 2112 are configured to move half 2106 and half 2108 in direction 2114. In this illustrative example, seal 2116 is present to seal half 2106 to half 2108 for resin infusion. Dry stringer preform 2120 is present in cavity 2118.

Connector 2122 is present to maintain contact between half 2106 and half 2108 during transport of stringer insert 2104. In some illustrative examples, connector 2122 takes the form of a magnet. Connector 2122 can maintain contact between half 2106 and half 2108 while dry stringer preform 2120 and stringer insert 2104 are picked and placed from forming tool 2102 to a heating tool bed.

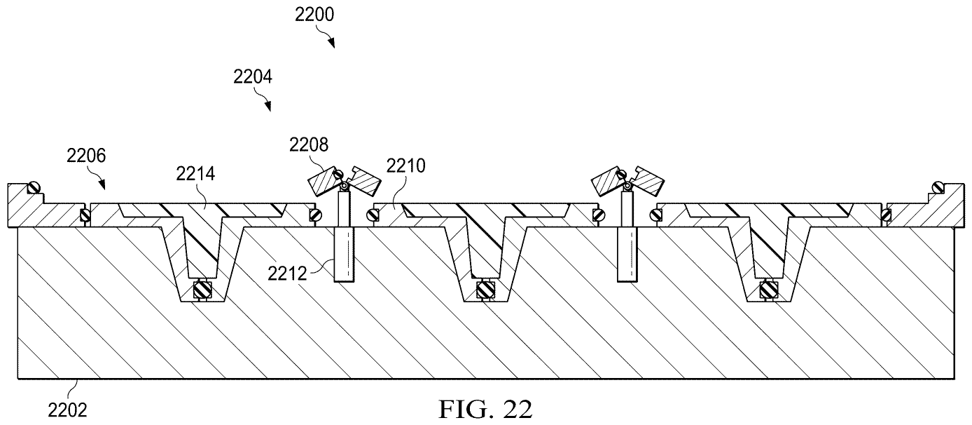

Turning now to FIG. 22, an illustration of a cross-sectional view of a resin infusion tooling system comprising a number of inserts is depicted in accordance with an illustrative embodiment. Resin infusion tooling system 2204 can be a physical implementation of resin infusion tooling system 202 of FIG. 2. In view 2200 of resin infusion tooling system 2204, heating tool base 2202 is a unitary heating tool base. Heating tool base 2202 comprises a plurality of cavities that remain the same size.

In this illustrative example, number of inserts 2206 is used to receive plurality of dry stringer preforms 2214 and hold plurality of dry stringer preforms 2214 in the cavities of heating tool base 2202. Number of inserts 2206 comprises panel inserts 2208 and stringer inserts 2210. Stringer inserts 2210 are configured to receive plurality of dry stringer preforms 2214. Panel inserts 2208 are configured to support a panel preform. In this illustrative example, panel inserts 2208 are moved upwards by actuators 2212 to allow for movement of stringer inserts 2210.

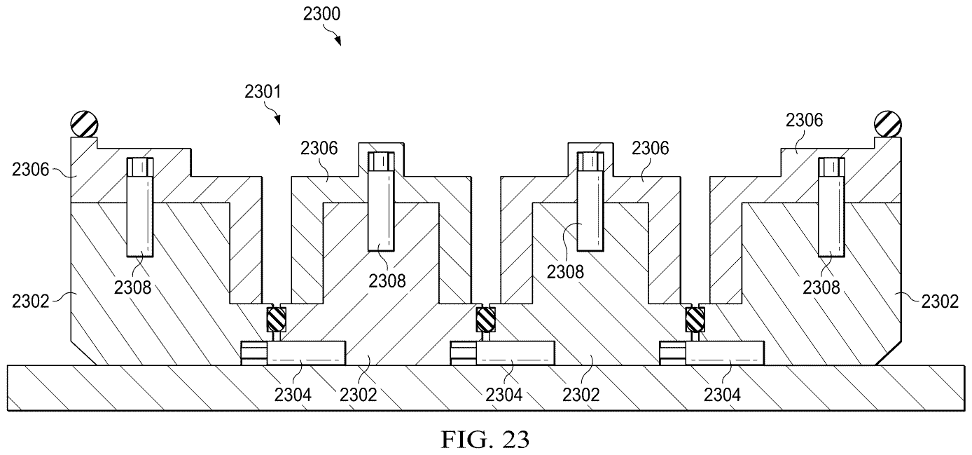

Turning now to FIG. 23, an illustration of a cross-sectional view of a resin infusion tooling system comprising a number of inserts is depicted in accordance with an illustrative embodiment. In view 2300, resin infusion tooling system 2301 having plurality of bed segments 2302 and number of inserts 2306 is presented. Resin infusion tooling system 2301 can be a physical implementation of resin infusion tooling system 202 of FIG. 2. In view 2300, actuators 2304 configured to move plurality of bed segments 2302 relative to each other are visible. Actuators 2304 can be activated to expand a plurality of cavities formed by plurality of bed segments 2302.

Additionally, actuators 2308 configured to move number of inserts 2306 are visible. Actuators 2308 are configured to move number of inserts 2306 towards or away from plurality of bed segments 2302.

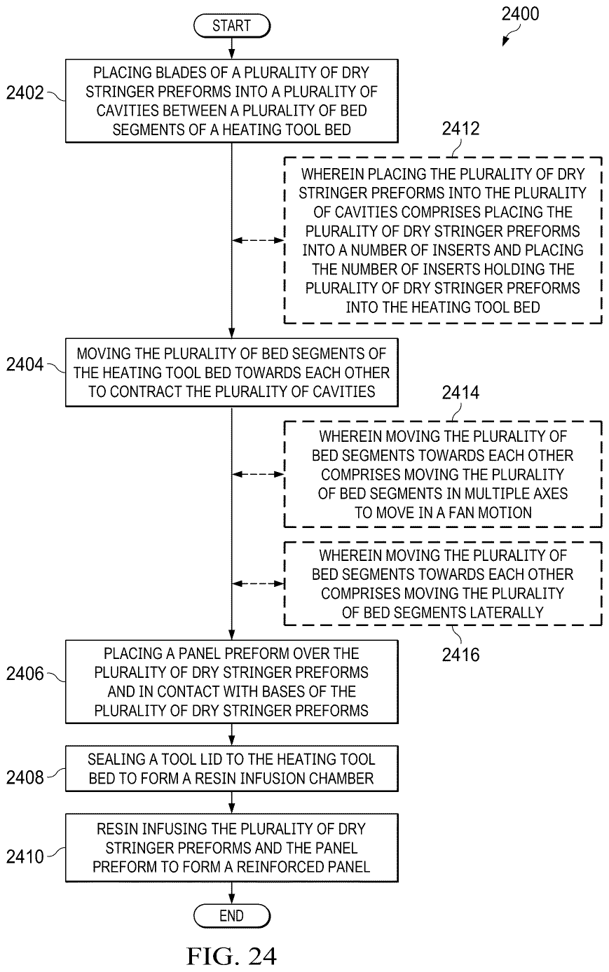

Turning now to FIG. 24, a flowchart of a method of performing resin infusion is depicted in accordance with an illustrative embodiment.

Method 2400 places blades of a plurality of dry stringer preforms into a plurality of cavities between a plurality of bed segments of a heating tool bed (operation 2402). In some illustrative examples, the plurality of cavities are expandable and are referred to as a plurality of expandable cavities. Method 2400 moves the plurality of bed segments of the heating tool bed towards each other to contract the plurality of cavities (operation 2404). Method 2400 places a panel preform over the plurality of dry stringer preforms and in contact with bases of the plurality of dry stringer preforms (operation 2406). Method 2400 seals a tool lid to the heating tool bed to form a resin infusion chamber (operation 2408).

Method 2400 resin infuses the plurality of dry stringer preforms and the panel preform to form a reinforced panel (operation 2410). Afterwards, method 2400 terminates.

In some illustrative examples, moving the plurality of bed segments towards each other comprises moving the plurality of bed segments in multiple axes to move in a fan motion (operation 2414). In some illustrative examples, bed segments are connected by hinges to provide a fan motion.

In some illustrative examples, moving the plurality of bed segments towards each other comprises moving the plurality of bed segments laterally (operation 2416). In some illustrative examples, the bed segments are moved laterally by a plurality of lateral actuators.

In some illustrative examples, placing the plurality of dry stringer preforms into the plurality of cavities comprises placing the plurality of dry stringer preforms into a number of inserts and placing the number of inserts holding the plurality of dry stringer preforms into the heating tool bed (operation 2412). In some illustrative examples, the number of inserts is made of a flexible material. In some illustrative examples, the number of inserts is made of a flexible metal. In some illustrative examples, the number of inserts comprises a plurality of inserts. In some illustrative examples, the number of inserts comprises a plurality of separable inserts. In some illustrative examples, the number of inserts comprises a plurality of separable inserts. In some illustrative examples, the number of inserts comprises stringer inserts and panel inserts.

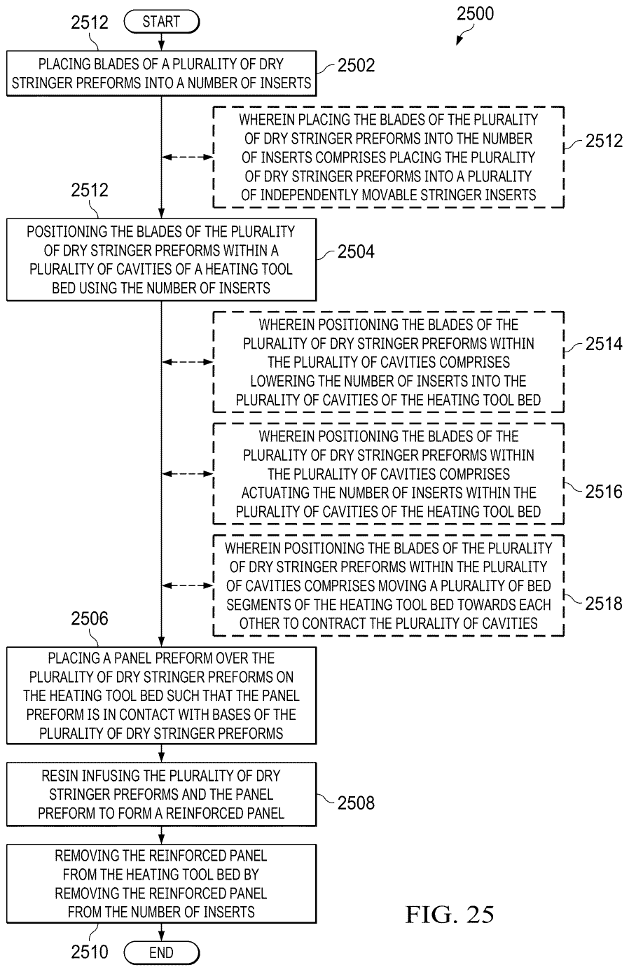

Turning now to FIG. 25, a flowchart of a method of performing resin infusion is depicted in accordance with an illustrative embodiment.

Method 2500 places blades of a plurality of dry stringer preforms into a number of inserts (operation 2502). Method 2500 positions the blades of the plurality of dry stringer preforms within a plurality of cavities of a heating tool bed using the number of inserts (operation 2504). Method 2500 places a panel preform over the plurality of dry stringer preforms on the heating tool bed such that the panel preform is in contact with bases of the plurality of dry stringer preforms (operation 2506). Method 2500 resin infuses the plurality of dry stringer preforms and the panel preform to form a reinforced panel (operation 2508). Method 2500 removes the reinforced panel from the heating tool bed by removing the reinforced panel from the number of inserts (operation 2510). Afterwards, method 2500 terminates.

In some illustrative examples, the number of inserts is made of a flexible material. In some illustrative examples, the number of inserts is made of a flexible metal. In some illustrative examples, the number of inserts comprises a plurality of inserts. In some illustrative examples, the number of inserts comprises a plurality of separable inserts.

In some illustrative examples, placing the blades of the plurality of dry stringer preforms into the number of inserts comprises placing the plurality of dry stringer preforms into a plurality of independently movable stringer inserts (operation 2512). In some illustrative examples, the number of inserts comprises stringer inserts and panel inserts. In some illustrative examples, the number of inserts comprises a plurality of separable inserts.

In some illustrative examples, positioning the blades of the plurality of dry stringer preforms within the plurality of cavities comprises lowering the number of inserts into the plurality of cavities of the heating tool bed (operation 2514). In some illustrative examples, vertical actuators associated with a heating tool bed move the number of inserts vertically relative to the heating tool bed. In some illustrative examples, the number of inserts are picked and placed into the plurality of cavities while the plurality of dry stringer preforms are in the number of inserts.

In some illustrative examples, positioning the blades of the plurality of dry stringer preforms within the plurality of cavities comprises actuating the number of inserts within the plurality of cavities of the heating tool bed (operation 2516). In some illustrative examples, lateral actuators are used to close the number of inserts to fit within the plurality of cavities.

In some illustrative examples, a plurality of inserts are used in conjunction with a plurality of bed segments. In some illustrative examples, positioning the blades of the plurality of dry stringer preforms within the plurality of cavities comprises moving a plurality of bed segments of the heating tool bed towards each other to contract the plurality of cavities (operation 2518).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C, or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 2414 through operation 2418 may be optional. As another example, operation 2512 through operation 2518 may be optional.

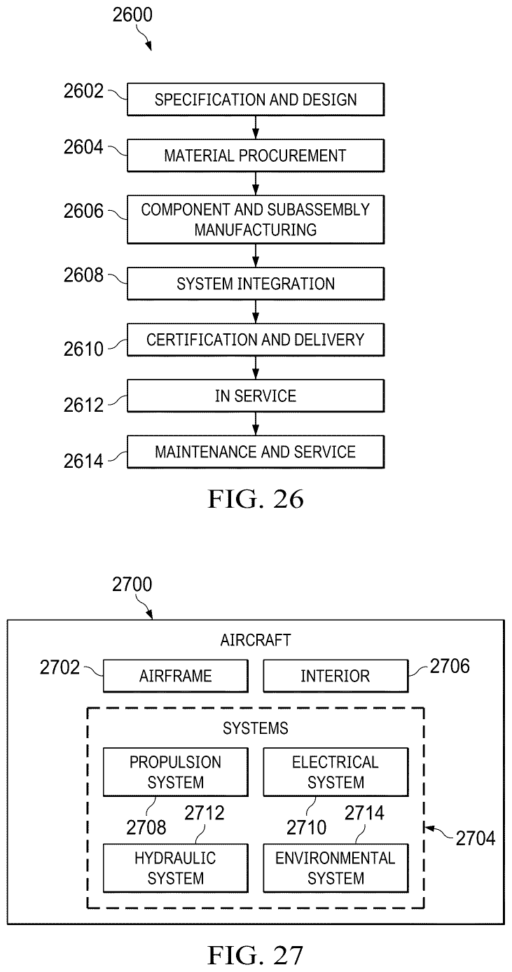

Illustrative embodiments of the present disclosure may be described in the context of aircraft manufacturing and service method 2600 as shown in FIG. 26 and aircraft 2700 as shown in FIG. 27. Turning first to FIG. 26, an illustration of an aircraft manufacturing and service method in a form of a block diagram is depicted in accordance with an illustrative embodiment. During pre-production, aircraft manufacturing and service method 2600 may include specification and design 2602 of aircraft 2700 in FIG. 27 and material procurement 2604.

During production, component and subassembly manufacturing 2606 and system integration 2608 of aircraft 2700 takes place. Thereafter, aircraft 2700 may go through certification and delivery 2610 in order to be placed in service 2612. While in service 2612 by a customer, aircraft 2700 is scheduled for routine maintenance and service 2614, which may include modification, reconfiguration, refurbishment, or other maintenance and service.

Each of the processes of aircraft manufacturing and service method 2600 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 27, an illustration of an aircraft in a form of a block diagram is depicted in which an illustrative embodiment may be implemented. In this example, aircraft 2700 is produced by aircraft manufacturing and service method 2600 of FIG. 26 and may include airframe 2702 with plurality of systems 2704 and interior 2706. Examples of systems 2704 include one or more of propulsion system 2708, electrical system 2710, hydraulic system 2712, and environmental system 2714. Any number of other systems may be included.

Apparatuses and methods embodied herein may be employed during at least one of the stages of aircraft manufacturing and service method 2600. One or more illustrative embodiments may be manufactured or used during at least one of component and subassembly manufacturing 2606, system integration 2608, in service 2612, or maintenance and service 2614 of FIG. 26.

The illustrative examples provide the ability to control the opening and closing of tooling surfaces to accommodate insertion of dry fiber preform into heated matched tooling without undesirable affects to preform/finished part or undesirable affects to the tooling surface. In some illustrative examples, the tooling surfaces are opened or closed by opening or closing a plurality of bed segments of the heating tool bed. In some illustrative examples, the tooling surfaces are opened or closed by opening or closing a number of inserts. In some illustrative examples, the number of inserts is bent or moved by bending a flexible material of the number of inserts. In some illustrative examples, the number of inserts are separable. In some illustrative examples, the number of inserts are hinged. In some illustrative examples, the number of inserts comprise stringer inserts. In some illustrative examples, the number of inserts comprise stringer inserts and panel inserts.

In some illustrative examples, there is separation of a matched tooling surface from a heated element which allows for faster, cheaper tooling replacement. In some illustrative examples, opening and closing matched tooling surfaces and integration of necessary seals enable gap infusion composite manufacturing. In some illustrative examples, making a matched tooling surface a removable feature allows for offline maintenance, easier and more cost efficient replacement, and a more robust solution that can more easily accommodate part design changes.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A resin infusion tooling system comprising:
a heating tool bed comprising a plurality of cavities formed between a plurality of bed segments movable relative to each other, wherein the plurality of cavities is expandable by movement of the plurality of bed segments relative to each other; and
a plurality of seals configured to seal the plurality of bed segments together for resin infusion of a plurality of dry stringer preforms in the plurality of cavities.

2. The resin infusion tooling system of claim 1 further comprising:
hinges connecting the plurality of bed segments to enable fanning movement of the plurality of bed segments relative to each other.

3. The resin infusion tooling system of claim 1 further comprising:
lateral actuators configured to move the plurality of bed segments laterally relative to each other.

4. The resin infusion tooling system of claim 1 further comprising:
a number of inserts configured to receive the plurality of dry stringer preforms and hold the plurality of dry stringer preforms within the plurality of cavities.

5. A resin infusion tooling system comprising:
a heating tool bed comprising a plurality of cavities configured to support a plurality of dry stringer preforms during resin infusion; and
a number of inserts configured to receive the plurality of dry stringer preforms and hold the plurality of dry stringer preforms within the plurality of cavities.

6. The resin infusion tooling system of claim 5, wherein the number of inserts comprises a plurality of inserts comprising stringer inserts, wherein each insert unit of the stringer inserts has a respective cavity configured to receive a dry stringer preform of the plurality of dry stringer preforms.

7. The resin infusion tooling system of claim 6, wherein the stringer inserts comprise separable insert units with halves separable from each other.

8. The resin infusion tooling system of claim 6, wherein the stringer inserts comprise whole insert units with respective cavities expandable by hinges.

9. The resin infusion tooling system of claim 6, wherein the plurality of inserts further comprise panel inserts positioned between the stringer inserts and configured to support a panel preform positioned over the stringer inserts and the panel inserts.

10. The resin infusion tooling system of claim 5, wherein the number of inserts comprises a unitary flexible insert with cavities configured to slide into the plurality of cavities of the heating tool bed.

11. The resin infusion tooling system of claim 5, wherein the heating tool bed comprises a plurality of bed segments movable relative to each other, wherein the plurality of cavities is expandable by movement of the plurality of bed segments relative to each other.

12. A method of performing resin infusion comprising:
placing blades of a plurality of dry stringer preforms into a plurality of cavities between a plurality of bed segments of a heating tool bed;
moving the plurality of bed segments of the heating tool bed towards each other to contract the plurality of cavities;
placing a panel preform over the plurality of dry stringer preforms and in contact with bases of the plurality of dry stringer preforms;
sealing a tool lid to the heating tool bed to form a resin infusion chamber; and
resin infusing the plurality of dry stringer preforms and the panel preform to form a reinforced panel.

13. The method of claim 12, wherein moving the plurality of bed segments towards each other comprises moving the plurality of bed segments in multiple axes to move in a fan motion.

14. The method of claim 12, wherein moving the plurality of bed segments towards each other comprises moving the plurality of bed segments laterally.

15. The method of claim 12, wherein placing the plurality of dry stringer preforms into the plurality of cavities comprises placing the plurality of dry stringer preforms into a number of inserts and placing the number of inserts holding the plurality of dry stringer preforms into the heating tool bed.

16. A method of performing resin infusion comprising:
placing blades of a plurality of dry stringer preforms into a number of inserts;
positioning the blades of the plurality of dry stringer preforms within a plurality of cavities of a heating tool bed using the number of inserts;
placing a panel preform over the plurality of dry stringer preforms on the heating tool bed such that the panel preform is in contact with bases of the plurality of dry stringer preforms;
resin infusing the plurality of dry stringer preforms and the panel preform to form a reinforced panel; and
removing the reinforced panel from the heating tool bed by removing the reinforced panel from the number of inserts.

17. The method of claim 16, wherein positioning the blades of the plurality of dry stringer preforms within the plurality of cavities comprises lowering the number of inserts into the plurality of cavities of the heating tool bed.

18. The method of claim 16, wherein positioning the blades of the plurality of dry stringer preforms within the plurality of cavities comprises actuating the number of inserts within the plurality of cavities of the heating tool bed.

19. The method of claim 16, wherein positioning the blades of the plurality of dry stringer preforms within the plurality of cavities comprises moving a plurality of bed segments of the heating tool bed towards each other to contract the plurality of cavities.

20. The method of claim 16, wherein placing the blades of the plurality of dry stringer preforms into the number of inserts comprises placing the plurality of dry stringer preforms into a plurality of independently movable stringer inserts.
